(19) United States
(12) Patent Application Publication
(10) Pub. No.: US 2007/0143442 A1
(43) Pub. Date: Jun. 21, 2007

(54) Scalable Publish/Subscribe Broker Network Using Active Load Balancing

(75) Inventors: Hui Zhang, New Brunswick, NJ (US); Samrat Ganguly, Monmouth Junction, NJ (US); Sudeept Bhatnagar, Plainsboro, NJ (US); Rauf Izmailov, Plainsboro, NJ (US)

Correspondence Address: NEC LABORATORIES AMERICA, INC., 4 INDEPENDENCE WAY, PRINCETON, NJ, 08540, US

(73) Assignee: NEC Laboratories America, Inc., Princeton, NJ (US)

(21) Appl. No.: 11/613,227

(22) Filed: Dec. 20, 2006

Related U.S. Application Data
(60) Provisional application No. 60/743,052, filed on Dec. 20, 2005.

(51) Int. Cl. G06F 15/16

(52) U.S. Cl. 709/217

(57) ABSTRACT

A scalable broker publish/subscribe broker network using a suite of active load balancing schemes is disclosed. In a Distributed Hashing Table (DHT) network, a workload management mechanism, consisting of two load balancing schemes on events and subscriptions respectively and one load-balancing scheduling scheme, is implemented over an aggregation tree rooted on a data sink when the data has a uniform distribution over all nodes in the network. An active load balancing method and one of two alternative DHT node joining/leaving schemes are employed to achieve the uniform traffic distribution for any potential aggregation tree and any potential input traffic distribution in the network.

### BACKGROUND OF THE INVENTION

This non-provisional application claims the benefit of U.S. Provisional Appl. Serial. No. 60/743,052, entitled “A SCALABLE PUBLISH/SUBSCRIBE BROKER NETWORK USING ACTIVE LOAD BALANCING,” filed Dec. 20,2005.

### BACKGROUND OF THE INVENTION

The present invention relates generally to networking, and more particularly, to active load balancing among nodes in a network in connection with information dissemination and retrieval among Internet users.

Publish/Subscribe enables a loose coupling communication paradigm for information dissemination and retrieval among Internet users. Publish/subscribe systems are generally classified into two categories: subject-based and content-based. In a subject-based publish/subscribe model, users subscribe to publishers based on a set of pre-defined topics. In a content-based model, a subscriber specifies his/her interested information defined on event content as the form of predicate-based filters or general functions, and the information published later is delivered to the subscriber if it matches his/her interests. For example, in content-based publish/subscribe model, a multi-dimensional data space is defined on d attributes. An event e can be represented as a set of <aᵢ, vᵢ>data tuples where vᵢ is the value this event specifies for the attribute aᵢ. A subscription can be represented as a filter f that is a conjunction of k (k≦d) predicates, and each predicate specifies a constraint on a different attribute, such as “aᵢ=X”, or “X≦aᵢ≦Y”.

Services suitable for content-based publish/subscribe interaction are many, such as stock quotes, RSS feeds, online auctions, networked game, located based services, enterprise activity monitoring and consumer event notification systems, and mobile alerting systems, and more are expected to come.

Along with the rich functionalities provided by content-based network infrastructure comes the high complexity of message processing derived from parsing each message and matching it against all subscriptions. The resulting message processing latency makes it difficult to support high message publishing rates from diverse sites targeted to a large number of subscribers. For example, NASDAQ real-time data feeds alone include up to 6000 messages per second in the pre-market hours; hundreds of thousands of users may subscribe to these data feeds. In order to support fast message filtering (matching) and forwarding, we require a scalable publish-subscribe broker network that resides between publishers and subscribers.

A Distributed Hashing Table (DHT) is an attractive technique in the design of a publish/subscribe broker network due to its self-organization and scalability characteristics. There have been many research efforts in the usage of a DHT substrate for in-network message filtering, with the research on the extension of DHT “exact matching” primitive to support range query functionality. However, accompanying such an extension has revealed many limitations or performance problems such as fixed predicate schema, subscription load explosion, and heavy load balancing cost, due to the mapping from multi-dimensional data space onto one-dimensional node space. Finding an efficient and integral solution for all those problems is at the least challenging.

An example of a known DHT system is Chord as disclosed in, e.g., I. Stoica, R. Morris, D. Karger, F. Kaashoek, and H. Balakrishnan, Chord: A peer-to-peer lookup service for internet applications, in ACM SIGCOMM, 2001, the content of which is incorporated by reference herein (hereinafter “Stoica”). Like all other DHT systems, Chord supports scalable storage and retrieval of arbitrary <key, data> pairs. To do this, Chord assigns each overlay node in the network an m-bit identifier (called the node ID). This identifier can be chosen by hashing the node's address using a hash function such as SHA-1. Similarly, each key is also assigned an m-bit identifier (the terms “key” and “identifier” are used interchangeably herein). Chord uses consistent hashing to assign keys to nodes. Each key is assigned to that node in the overlay whose node ID is equal to the key identifier, or follows it in the key space (the circle of numbers from 0 to 2^{m}-1). That node is called the successor of the key. An important consequence of assigning node IDs using a random hash function is that location on the Chord circle has no correlation with the underlying physical topology.

The Chord protocol enables fast, yet scalable, mapping of a key to its assigned node. It maintains at each node a finger table having at most m entries. The i-th entry in the table for a node whose ID is n contains the pointer to the first node, s, that succeeds n by at least 2ⁱ⁻¹ on the ring, where 1≦i≦m. Node s is called the i-th finger of node n.

Suppose node n wishes to lookup the node assigned to a key k (i.e., the successor node x of k). To do this, node n searches its finger table for that node j whose ID immediately precedes k, and passes the lookup request to j. j then recursively (or iteratively) repeats the same operation; at each step, the lookup request progressively nears the successor of k, and the search space, which is the remaining key space between the current request holder and the target key k, shrinks quickly. At the end of this sequence, x's predecessor returns x's identity (i.e., its IP address) to n, completing the lookup. Because of the way Chord's finger table is constructed, the first hop of the lookup from n covers (at least) half the identifier space (clockwise) between n and k, and each successive hop covers an exponentially decreasing part. From this, it follows that the average number of hops for a lookup is O(log N) in an N-node network.

For a publish/subscribe broker network, potential system operations are classified into the following types:
message forwarding, which involves the operations of importing the original messages from publishers/subscribers and re-distributing them (possibly after some processing) following the system protocol.
message parsing, which involves the operations of parsing the original message texts to subtract the attribute names and values and store them in the specific data structures dependent on the main memory matching algorithm implemented in the system.
message matching, which involves the operations of in-memory matching between events and subscriptions in individual nodes.
message delivery, which involves the operations of notifying the interested subscribers of the matched events after the message matching procedure.

Among the these four types of workloads, message forwarding is least likely to become the performance bottleneck provided that the forwarding times on each original message are under control (e.g., O(logN) times where N is the network size). For example, state-of-art in-memory matching algorithms can support millions of subscriptions but only with the throughput of incoming events at hundreds per second, while typical application-layer UDP forwarding of IPV4 packets on a PC can run at 40,000 packets per second, and optimized implementations of DHT routing lookup forwarding can reach 310,000 packets per second.

Message parsing belongs to CPU-intense workloads. Previous designs on publish/subscribe systems associated a broker node with a set of publishers (and/or subscribers), and implicitly assigned that node the parsing task of the original messages from them. However, even if the average message arrival rate was not high, bursty input traffic could still overwhelm the node with excessive CPU demand during the peak hours. This is a potential performance bottleneck.

The cost of message matching and delivery is a non-decreasing function of the event arrival rate and the number of active subscriptions. Intuitively, there is no need to decentralize the data structure of a matching algorithm as long as the data structure fits into the main memory and the event arrival rate does not exceed the processing (including both matching and delivery) rate. Therefore, along with topic (attribute name)-based event filtering and subscription aggregation, it is desirable to finish the tasks of message matching and delivery within a single node, if possible. When a node's message matching and delivery workload is close to some threshold, it would further be desirable to employ a load balancing scheme to shift the workloads (arriving events and/or active subscriptions) to other nodes.

In view of the above, it is desirable to utilize DHT as an infrastructure for workload aggregation/distribution in combination with novel load balancing schemes to build a scalable broker network that enables fast information processing for publish/subscribe based services.

### SUMMARY OF THE INVENTION

In accordance with aspects of the present invention, a scalable broker publish/subscribe broker network using a suite of active load balancing schemes is disclosed. In a Distributed Hashing Table (DHT) network, a workload management mechanism, consisting of two load balancing schemes on events and subscriptions respectively and one load-balancing scheduling scheme, is implemented over an aggregation tree rooted on a data sink when the data has a uniform distribution over all nodes in the network. An active load balancing method and one of two alternative DHT node joining/leaving schemes are employed to achieve the uniform traffic distribution for any potential aggregation tree and any potential input traffic distribution in the network.

In accordance with an aspect of the invention, a method for balancing network workload in a publish/subscribe service network is provided. The network comprises a plurality of nodes that utilize a protocol where the plurality of nodes and publish/subscribe messages are mapped by the protocol onto a unified one-dimensional overlay key space, where each node is assigned an ID and range of the key space and where each node maintains a finger table for overlay routing between the plurality of nodes, and where event and subscription messages are hashed onto the key space based on event attributes contained in the messages, such that an aggregation tree is formed between a root node and child nodes among the plurality of nodes in the aggregation tree associated with an attribute A that send messages that are aggregated at the root node. The method comprises: receiving aggregated messages at the root node for processing of the aggregated messages; and upon detecting excessive processing of the aggregated messages at the root node, rebalancing network workload by pushing a portion of the processing of the aggregated messages at the root node back to a child node in the aggregation tree.

For subscription message processing, the method further comprises: a node x receiving an original subscription message m for redistribution in the network; the node x picking a random key for subscription message m; the node x sending the subscription message to a node y, where the node y is responsible for the key in the key space; parsing the subscription message at the node y and constructing a new subscription message n; and sending subscription message n to the root node z and replicating the subscription message n at each node in the network between the node y and the root node z, wherein each node in the aggregation tree records a fraction of subscription messages forwarded from a child of the node in the aggregation tree, and further wherein the root node z is identified by picking an attribute A contained in m and hashing A onto the overlay key space.

When the root node z is overloaded with subscription messages from the aggregation tree; the method further comprises: the root node z ranking all child nodes by the fraction of subscription messages forwarded to node z from each child node and marking the child nodes as being in an initial hibernating state; the root node z selecting a node l with the largest fraction of subscription messages among the hibernating child nodes; the root node z unloading all subscription messages received from the node l back to the node l;the root node z marking the node l as being in an active state, and forwarding all subsequent subscription messages in an event aggregation tree associated with attribute A to the node l.

For event message processing, the method further comprises: a node x receiving an original event message m for redistribution in the network; the node x picking a random key for the event message m; the node x sending the event message to a node y, where the node y is responsible for the key in the key space; parsing the event message at the node y and constructing a new event message n; and sending the event message n to the root node z and replicating the event message n at each node in the network between the node y and the root node z, wherein each node in the aggregation tree records a fraction of event messages forwarded from a child of the node in the aggregation tree, and further wherein the root node z is identified by picking each attribute A contained in m and hashing A onto the overlay key space.

When the root node z is overloaded with event messages from the aggregation tree; the method further comprises: the root node z ranking all child nodes by the fraction of event messages forwarded to the node z from each child node and marking the child nodes as being in an initial hibernating state; the root node z selecting a node l with the largest fraction of event messages among the hibernating child nodes; replicating all messages from the subscription aggregation tree for attribute A at the node l and requesting that the node l hold message forwarding and locally process event messages; and the root node z marking the node l as active.

An order of load balancing operations can be scheduled at an overloaded node root node n among the plurality of nodes, wherein node n is simultaneously overloaded by event and subscription messages by: node n determining a target processing rate r: signaling a plurality of child nodes to node n to stop forwarding event messages to node n such that an actual arrival rate of event messages at node n is no greater than r; determining an upper bound th on the number of subscription messages that can be processed at node n based on r; signaling a plurality of child nodes to node n to stop forwarding subscription messages based on th; and unloading subscription messages from node n to the plurality of child nodes.

In accordance with another aspect of the invention, a new node is added to the network using an optimal splitting (OS) scheme, wherein the OS scheme comprises the new node joining the network by: finding a node owning a longest key range; and taking ½ of the key range from the node with the longest key range. If a plurality of nodes have an identical longest key range, then the method involves randomly picking one of the nodes owning the identical longest key range. A node x can likewise be removed from the network using an OS scheme, by the node x finding a node owning a shortest key range among the plurality of nodes and an immediate successor node, and the node x instructing the node owning the shortest key range to leave a current position in the network and rejoin at a position of node x. If the immediate successor node owns the shortest key range, then the immediate successor node is instructed to leave a current position. If the immediate successor node does not own the shortest key range and a plurality of nodes own the shortest key range, then one of the nodes having the shortest key range is selected at random.

In accordance with another aspect of the invention, a new node can be added to the network using a middle point splitting (MP-k) scheme, which comprises the new node joining the network by randomly choosing K nodes on the overlay space and if a plurality of nodes among the K nodes have longest key range, then randomly selecting a node among the plurality of nodes with the longest key range. A node x can be removed from the network using the MP-k scheme by the steps of: the node x picking K random nodes and an immediate successor node in the network; and the node x selecting a node owning the shortest key range and requesting that the node owning the shortest key range leave a current position in the network and rejoin at a position of node x, wherein, if the immediate successor node to node x has the shortest key range, giving priority to the immediate successor node to node x, and further wherein if the immediate successor node to node x does not own the shortest key range and a plurality of nodes among the K random nodes own the shortest key range, randomly selecting a node among the plurality of nodes owning the shortest key range.

The advantages of the invention will be apparent to those of ordinary skill in the art by reference to the following detailed description and the accompanying drawings.

### BRIEF DESCRIPTION OF THE DRAWINGS

FIG. 1 is an illustration of a Shuffle network comprising a plurality of nodes with a half-cascading load distribution;

FIG. 2 is an example of an exemplary 8-node Shuffle network;

FIG. 3 is a schematic of an illustrative Shuffle node architecture;

FIG. 4 is a depiction of an exemplary 5-node Shuffle network showing a node hidden behind an immediate predecessor node on the key space;

FIG. 5a depicts incoming load distribution on a root node using different join schemes for an exemplary 48 node network;

FIG. 5b depicts incoming load distribution on a root node using different join schemes for an exemplary 64 node network;

FIG. 5c depicts incoming load distribution on a root node using different join schemes for an exemplary 768 node network;

FIG. 5d depicts incoming load distribution on a root node using different join schemes for an exemplary 1024 node network;

FIG. 6a depicts the distribution of the ratio of key space fraction and network size fraction for an optimal splitting (OS) join scheme for an exemplary 1024 node network;

FIG. 6b depicts the distribution the ratio of key space fraction and network size fraction for a Random-1 join scheme for an exemplary 1024 node network;

FIG. 6c depicts the distribution of a ratio of key space fraction and network size fraction for a Random-10 join scheme for an exemplary 1024 node network;

FIG. 6d depicts the distribution of a ratio of key space fraction and network size fraction for an MP-10 join scheme for an exemplary 1024 node network;

FIG. 7a depicts the probability of failure of cascaded load balancing in attaining a target load level for an exemplary 768 node network for a plurality of joining schemes;

FIG. 7b depicts the probability of failure of cascaded load balancing in attaining a target load level for an exemplary 1024 node network for a plurality of joining schemes;

FIG. 8a depicts control traffic overhead for different load balancing schemes with an OS joining scheme for an exemplary 768 node network;

FIG. 8b depicts control traffic overhead for different load balancing schemes with an OS joining scheme for an exemplary 1024 node network;

FIG. 8c depicts control traffic overhead for different load balancing schemes with an MP-10 joining scheme for an exemplary 768 node network;

FIG. 8d depicts control traffic overhead for different load balancing schemes with an MP-10 joining scheme for an exemplary 1024 node network;

FIG. 9a depicts subscription movement overhead for different load balancing schemes with an OS joining scheme for an exemplary 768 node network;

FIG. 9b depicts subscription movement overhead for different load balancing schemes with an OS joining scheme for an exemplary 64 node network;

FIG. 10a depicts message forwarding overhead for different load balancing schemes for an exemplary 768 node network;

FIG. 10b depicts message forwarding overhead for different load balancing schemes for an exemplary 64 node network;

FIG. 11 depicts subscription availability with an OS join scheme vs. node failure probability for an exemplary network sizes for cascaded and random caching schemes;

FIG. 12 depicts subscription availability with different join schemes vs. node failure probability for an exemplary 64 node network.

### DETAILED DESCRIPTION OF THE PREFERRED EMBODIMENT

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

In accordance with an aspect of the present invention, subject-based and content-based publish/subscribe services are supported within a single architecture, hereinafter referred to as “Shuffle.” It is designed to overlay a set of nodes (either dispersed over wide area or residing within a LAN), that are dedicated as publish/subscribe servers. The network may start with a small size (e.g., in tens) and eventually grow to thousands of nodes with the increasing popularity of the services.

Each Shuffle node includes a main-memory processing algorithm for message matching, and can operate as an independent publish/subscribe server. An exemplary main memory processing algorithm is disclosed in, for example, F. Fabret, H. A. Jacobsen, F. Llirbat, J. Pereira, K. A. Ross, and D. Shasha, Filtering algorithms and implementation for very fast publish/subscribe systems, in ACM SIGMOD 2001, the content of which is incorporated herein. In addition, all nodes organize into an overlay network and collaborate with each other in workload aggregation/distribution. While Shuffle supports subject level (attribute-name level) message filtering through overlay routing, the main functionality of the overlay network is to aggregate related messages for centralized processing if possible and distribute the workload from overloaded nodes to other nodes in a systematical, efficient, and responsive way.

Shuffle uses the original Chord DHT protocol to map both nodes and publish/subscribe messages onto a unified one-dimensional key space. The Chord protocol is disclosed in Stoica. In accordance with Chord, each node is assigned an ID and a portion (called its range) of the key space, and maintains a Chord finger table for overlay routing. Both event and subscription messages are hashed onto the key space based on some of the event attributes contained in the messages, and therefore are aggregated and filtered in a coarse degree (attribute-name level). For each attribute interested in the pub/sub services, the routing paths from all nodes to the node responsible for that attribute (hereinafter called its “root node”) naturally forms an aggregation tree, which Shuffle uses to manage the workloads associated with that attribute. As will be appreciated by those skilled in the art, in Chord routing tables there are usually more than log N entries which are for routing robustness or hop-reduction consideration. However, in Shuffle each routing hop strictly follows one of the log N links as defined in finger tables. In this regard, only the aggregation trees following those links are desired in the Shuffle system. It will be appreciated by those skilled in the art that the use of Chord is illustrative, as other DHT protocols may be employed, including Tapestry and Pastry.

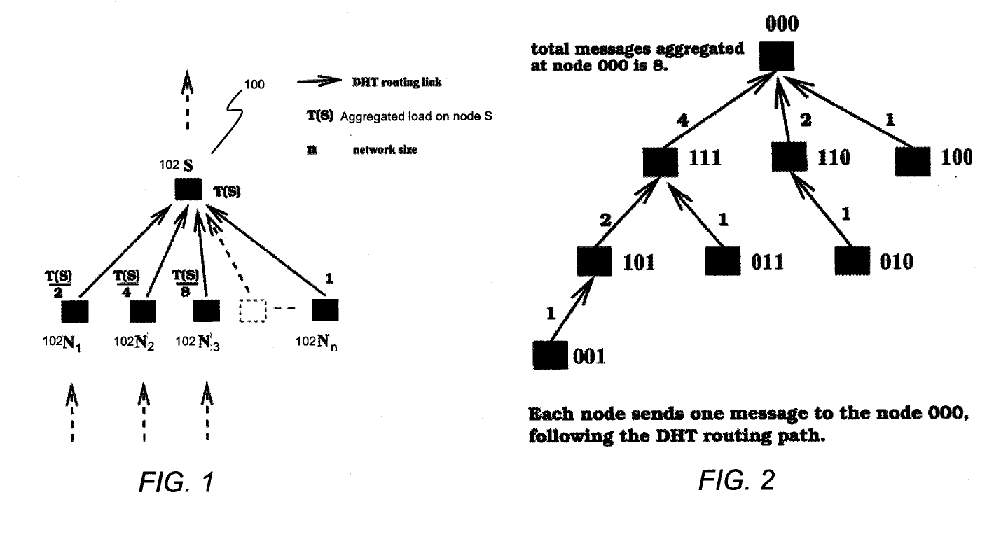

Referring now to FIG. 1, an exemplary Shuffle network 100 comprises a plurality of nodes n=2^{k}. Assuming an equal partition of the overlay space among the nodes 100N₁,100N₂, 100N₃, . . . , 100Nₙ, there is a specific load distribution in an aggregation tree when all nodes generate the same amount of messages to a root node. If the total key space length is x, then an equal partition of the overlays (key) space in a Shuffle network with n nodes means that each node is allocated a part of the key space with the length k/n. As depicted in FIG. 1, it is further assumed that every node generates one unit message to the root node and some non-leaf node 100S has aggregated totally T(S) unit messages in the overlay forwarding. It can be shown (as described below), that S has totally log(T(S)) immediate children in the tree, and the messages forwarded by the children follows the half-cascading distribution: one child 100N₁, forwards ½ of the total messages T(S), one child 100N₂ forwards ¼ of T(S), and the like, until one child which is a leaf node 100S contributes one unit message. As a numeric example, referring now to FIG. 2, an aggregation tree rooted at node 000 in an 8-node Shuffle network with a 3-bit key space is depicted. It can be verified that all non-leaf nodes have the half-cascading traffic distribution on their incoming links.

When the key space is not evenly partitioned among the nodes, the aggregation load will not follow an exact half-cascading distribution. It is well known that the original node join scheme in Chord can cause a 0(logn) stretch in the key space partition. In accordance with an aspect of the invention, two node joining/leaving schemes for even space partition may be employed:

Optimal Splitting (OS)
Joining—A new node joins the network by finding the Shuffle node owning the longest key range and taking half of the key range from that node. If there are multiple candidate nodes with the longest key ranges, a tie is broken with a random choice.
Leaving—The leaving node x finds the Shuffle node owning the shortest key range, and asks it to leave the current position and rejoin at y's position. When there are multiple candidate nodes with the shortest key ranges, x's immediate successor node is given the priority if it is one candidate; otherwise, a tie is broken with a random choice.

Middle-Point Splitting with k-Choice (MP-K)
Joining—A new node joins the network by randomly choosing K points on the overlay space (e.g., hashing the nodes IP address by K times, and taking half of the range from the node owning the longest key range among the (potentially) K nodes responsible for the K points. When there are multiple nodes with the longest key ranges, a tie is broken with a random choice.
Leaving—The leaving node x picks K random nodes along with its immediate successor node, and asks the node owning the shortest key range to leave its current position and rejoin at y's position. If x's immediate successor node has the shortest key range, it is given the priority; otherwise, a tie is broken with a random choice.

The OS scheme can achieve optimal space partition, but requires global information. The MP-K scheme can limit the overhead in the join/leave procedure but may cause larger skew in the space partition than the OS scheme. Thus, the choice of the node join/leave scheme is a consideration of node dynamics and “system openness.”

In a Shuffle system with an OS scheme and a uniform message generation rate at all nodes (i.e., uniform input traffic distribution), a half-cascading load distribution can be achieved if the network size is 2^{k} When the network size is not a power of 2, the aggregation load still has a distribution close to the half-cascading expedient, which is referred to herein as a α—cascading distribution. Analytical results are described further below.

With a half-cascading distribution, a simple pushing scheme can be used to achieve optimal load balancing with little overhead. In a Shuffle aggregation tree, initially only the root node processes the aggregated messages and all other nodes just forward messages. In this regard, the root node is considered to be in an “active” state with the remainder of the nodes in a “hibernating” state. When the processing workload is excessive, the root node rebalances the workload by activating the child forwarding half of the workload and pushing that part of the workload back to that child for processing. This equates to splitting the original aggregation tree into two with each node acting as one root node. The pushing operation may be implemented recursively until each activated node can accommodate the processing workload assigned to that node. With the half-cascading distribution, an active node can thus reduce half of its workload after each pushing operation. Therefore, the maximal number of pushing operations each node incurs is log n, where n is the network size. If the workload after log n operations is still too high for a node, all other nodes can be considered to be overloaded. This is because the current workload of this node is related to only on the messages the node itself generates, where all nodes generate the same amount of messages. When the load distribution is α—cascading, it can be shown that a node can still reduce its workload by a constant factor (e.g., ¼ instead of ½) after a single pushing operation.

There are two types of messages in Shuffle: subscription messages and event messages. Accordingly, the aggregation trees are classified into these two types, and different load balancing schemes based on a general pushing scheme are employed.

As a proxy for some subscribers, the first assignment of a Shuffle node x upon receiving an original subscription message m is to re-distribute it in the system. Shuffle node x picks a random key for m (e.g., by hashing a subscription ID contained in the message) and sends it to the node y responsible for that key in the overlay space. Node y is in charge of parsing m, constructing a new subscription message n tailored for fast overlay routing and the chosen in-memory message matching algorithm, and sending n to a destination node z, which node y decides by arbitrarily picking an attribute A specified in m and hashing A onto the overlay space. In this regard, for an unsubscribe consideration, the random keys for the paired subscribe/unsubscribe messages should be the same, and the choice of the attribute A has to be made consistently even if y is later replaced by another node for the key range containing the random key. Node z is considered to be the root node of the subscription/aggregation tree associated with the attribute A, and node y generates one message into the aggregation tree by sending n to z through the overlay routing.

This randomization (message shuffling) process incorporates the concept of optimal load balancing in packet switching. See I. Keslassy, C. Chang, N. McKeown, and D. Lee, Optimal load-balancing, in Infocom 2005, Miami, Fla. 2005, the content of which is incorporated by reference. The randomization process achieves two goals. In accordance with the first goal, the randomization makes the distribution of the input traffic for any potential subscription aggregation tree uniform on the key space. Employing such randomization and the OS scheme, Shuffle can obtain optimal load balancing on subscription aggregation/distribution. In accordance with the second goal, the cost of message parsing on subscriptions is distributed evenly throughout the system. Shuffle thus eliminates a potential performance bottleneck due to (subscription) message parsing operations.

On a routing path from a message sender y to the root node z, the subscription message n will be replicated at each hop in accordance with Shuffle. In addition, each node in an aggregation tree will record the fraction of the subscriptions that each of its children contributes in message forwarding. When node z is overloaded with too many subscriptions from an aggregation tree A, it applies a loading-forwarding scheme for load balancing.

In the loading-forwarding scheme, the root node z ranks all children in the tree by the traffic fraction, and marks them as “hibernating” initially. Next, among all “hibernating” children, the root node z selects a node l with the largest traffic fraction. Root node z then unloads all subscriptions forwarded from node l by sending corresponding “unsubscribe” messages into node z's local message matching algorithm. Root node z also requests that node l load the cached copies from its local database and input the same into the message matching algorithm at node l. Next, root node z then marks node l as “active,” and forwards all messages in the event aggregation tree of the same attribute A to node l in the future. If node z needs to unload more subscriptions locally, the process loops back to picking another node l with the largest traffic fraction.

With respect to event processing, as a proxy for some publishers, the first assignment of a Shuffle node x at importing an original event message m is also traffic shuffling. When node y receives m after the shuffling step, it parses m, constructs a new event message n by appending the original event after some new metadata, and sends a copy of n to each destination node z responsible for the hashed key of one of the attributes specified in m.

In an event aggregation tree, each node also records the fraction of the events that each of its children contributes in message forwarding. When node z is overloaded with too many events from an aggregation tree A, it applies a replicating-holding scheme for load balancing.

In accordance with the replicating-holding scheme, root node z ranks all the children in the aggregation tree A by the traffic fraction, and marks them as “hibernating” initially. Next, among all “hibernating” children, root node z selects a node l with the largest traffic fraction. Node z will replicate all messages from the subscription aggregation tree for the same attribute A at node l, and request node l to hold message forwarding in the future. Thus, node l will instead process all the events it receives with its message matching algorithm. Root node z then marks node l as “active”, and the process loops back to selecting a new node l if node z needs to reflect more arriving events.

The root node z only transfers to node l those subscription messages that were not forwarded by node l in the subscription aggregation tree. As the fraction a of message forwarding from node l to node z in the event tree of an attribute is the same as the fraction β from node l to node z in the subscription tree of the same attribute, reducing the event workload by a factor α on node z requires transferring only (1-α) of the subscription messages in z. This saving is obvious in the first few replication operations which dominate the workload reduction.

In Shuffle the replicating-holding scheme is used recursively on each active node for event load balancing.

The scheme for scheduling the order of load balancing operations on events and subscriptions at an overloaded node, n, is: First, node n determines its target event processing rate r; using the replication-holding scheme, node n stops as many of its children as required from forwarding events to itself so that the actual event arrival rate to itself is at most r; if node n stops its child n1 from forwarding events, then the aggregation tree rooted at n is split into two disjoint trees rooted at n and n1, respectively. Then, based on r and its local workload model, node n determines the upper bound on the number of subscriptions it should manage, say, th; it then uses the loading-forwarding scheme to off-load subscriptions to its children such that the subscription load is at most th.

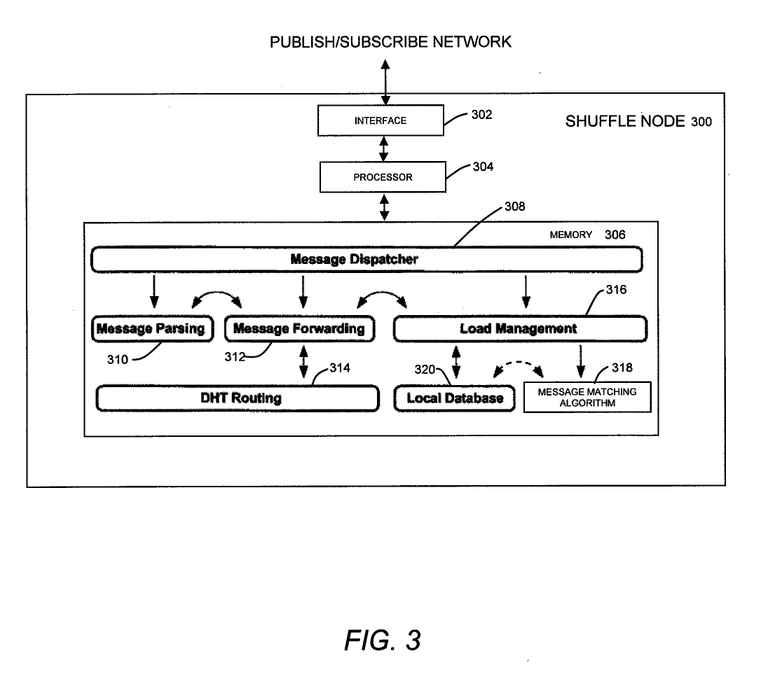

Referring now to FIG. 3, a schematic is shown of a Shuffle node 300 including an illustrative software architecture for implementing Shuffle functionality. The shuffle node 300 includes a communications interface 302 coupled to a processor 304 as will be appreciated by those skilled in the art for executing machine readable instructions stored in memory 306. The software architecture comprises a message dispatcher engine 308, which receives each incoming message at the node 300 and assigns the message to a processing component based on message type. In this regard, there are three types of messages classified as follows: (1) an original message prior to shuffling; (2) an original message after shuffling; and (3) a shuffle message. A message parsing engine 310 takes an original message after shuffling, and generates a corresponding Shuffle message. A message forwarding engine 312 cooperates with the message parsing engine 310 and the message dispatcher engine 308 to implement all routing related functionalities on top of the DHT substrate shown at 314, which supports the basic DHT primitives and implements the Shuffle node join/leave scheme described above. A load management engine 316 provides load balancing functionality, including loading-forwarding and replicating-holding, as described above. A matching module 318 implements an in-memory message matching algorithm, and couples with a local database 320 to record locally cached subscriptions.

To maintain efficiency in an open attribute space, each Shuffle node 300 keeps a record of the active attributes which are being specified in some active subscriptions. When a subscription aggregation tree under some attribute is newly constructed or deceased, the root node is responsible for broadcasting the corresponding information to the system. Efficient broadcasting in Shuffle can be achieved, for example, by the technique disclosed in S. El-Ansary, L. O. Alima, P. Brand, and S. Haridi, Efficient broadcast in structured p2p networks, in Proc. of IPTPS, 2003, the content of which is incorporated by reference. With the active attribute list, a node can eliminate all un-subscribed attributes contained in an original event message and only sends it to the event aggregation trees of those active attributes.

The goal of message shuffling is to uniformly transform the unpredictable distribution of the input traffic coming from publishers/subscribers into the network. Therefore, the extra hops due to overlay routing should be avoided if possible. When node dynamics are relatively low in the system and each node can maintain the list of all active nodes in the system, the routing cost for message shuffling can be reduced significantly by sending the original event/subscription messages directly to their destination nodes for processing.

The inventors have analyzed the load distribution in a Shuffle system with an OS scheme.

In a first case when the Shuffle network size is a power of 2 (i.e., 2^{k}), the OS scheme will assign the same length of key range to each node. With the uniform input traffic distribution on the key space due to message randomization, it can be shown that in any aggregation tree, each Shuffle node has the half-cascading load distribution on its children in terms of the incoming aggregated messages.

As a proof sketch, W.o.l.g, it is assumed the key space is [0, 2^{k}-1] and the node IDs are also from 0 to 2^{k}-1, and the ID of the root node is 0 (also 2^{k} in the ring torus).

To show the universal existence of the half-cascading load distribution, the proof starts from the root node. For the root node, its (logn=k) children are the nodes (2^{k}-1), (2^{k}-2), . . . ,(2^{k}-2^{k-1}). Notice, only (2^{k}-1) is an odd number and the root ID is an even number. For any other node having an ID which is also an odd number, the routing paths from this node to the root node must go through node (2^{k}-1) because all possible routing hops cover a distance of even length (2, 2², etc) except the last hop with a distance of 1. Therefore, all odd-number nodes will reside in the subtree rooted at node (2^{k}-1). Analogously, no even-number nodes will reside in the subtree rooted at node (2^{k}-1). Therefore, node (2^{k}-1) aggregates the messages of (2^{k-1}) nodes. With the uniform input traffic distribution, node (2^{k}-1) contributes ½ of the total messages that the root node receives.

Analogously, it can be shown that node (2k -2) is rooted at the subtree of the

$$\frac{{2}^{k}}{4}$$

nodes having IDs that are even and become odd after dividing by 2, node (2^{k}-4) is rooted at the subtree of the

$$\frac{{2}^{k}}{8}$$

nodes having IDs that are even and become odd after dividing by 4, and so on. Therefore, the root node has the half-cascading load distribution on its logN children. Repeating this analysis can show the same conclusion for all other nodes.

When the Shuffle network size is not a power of 2, the key ranges that OS scheme will assign to the nodes may have the length stretch of 2 in the worst case. With the uniform input traffic distribution on the key space, the input traffic distribution on the nodes will also have a stretch-2 in the worst case. In this situation, it can shown that in any aggregation tree for any non-leaf node x, there is at least one child which contributes no less than ¼ of the total load aggregated on x.

As a proof sketch, W.o.l.g, it is assumed the network size is 2^{k}+m (m<2^{k}) where the first 2^{k} nodes in terms of joining time are called the “old” nodes and the rest m nodes are called the “new” nodes. In this regard, any “new” node owns a key range no longer than that of any “old” node. Let the key space be [0, 2^{k+1}-1], where each “old” node is assigned an even-number ID, and each “new” node is assigned an odd-number ID.

For an aggregation tree rooted at an “old” node, when the network size is 2^{k}, the largest subtree rooted at some child contains 2^{k-1} nodes. When the network size becomes 2^{k}+m, it can be shown (analogous to the even-odd analysis discussed above with respect to network size at a power of 2), the subtree rooted at the same child will contain at least 2^{(k-2)} “old” nodes. Even if none of m “new” nodes reside in this subtree, the aggregated load in this subtree will be no less than

$$\frac{{2}^{k - 1}}{m + 2 * {2}^{k - 1}} > \frac{1}{4}$$

given that the input traffic stretch on the nodes will be more than 2, and any “new” node owns a key range no longer than that of any “old” node. Analogously, the same conclusion can be shown for all other nodes and aggregation trees rooted at the “new” node.

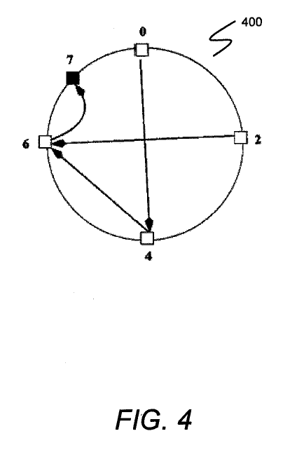

Therefore, a node can shift at least ¼ of its workload upon a single pushing operation. However, the upper bound of the maximal aggregation load fraction can be arbitrarily close to 1 due to the hidden parent phenomenon. As shown in FIG. 4, there is shown an exemplary 5-node Shuffle network 400 where node 7 is hidden behind node 6 in an aggregation tree rooted at itself. In this example, the key space is [0, 7], and node 7 joins after the nodes 0, 2, 4, and 6. It turns out that node 7 is not pointed by any node's finger table except its immediate predecessor—node 6. Thus, node 7 is considered to be hidden behind node 6, since all other nodes communicate with it through node 6 in overlay routing. Accordingly, in the aggregation tree rooted at node 7, it has only one child which forwards the messages from the rest of the network. Fortunately, this hidden node will either be a root node or a leaf node in any aggregation tree. Therefore Shuffle load balancing still works effectively on most of the nodes in an aggregation tree.

In an exemplary evaluation, the Shuffle scheme was implemented with the underlying DHT using a basic version of Chord. To assign keys in the system, the source code for consistent hashing from a p2psim simulator was employed. The p2psim is a simulator for peer-to-peer protocols, available at http://pdos.csail.mit.edu/p2psim. Since the shuffling process makes the traffic distribution uniform and the primary interest was in a heavy load scenario, the simulations were performed on the granularity of traffic distribution, as opposed to at the packet level.

In these simulations, nodes join the system sequentially. The network sizes chosen for the simulations utilized 48, 64, 768 and 1024 nodes. These choices of size were made for two reasons as they represent: a) both power of 2 and non-power of 2 networks; and b) small and large network sizes. The joining point for each node was determined using three schemes, including OS and MP-k (described above), and Random-k. In accordance with the latter, a new node joins the network by randomly choosing K points on the overlay space and joining that node at the point that lies in the longest key range. By way of contrast, in MP-k the node joins at the mid-point of the longest range. In Random-k, the node joins at the randomly chosen point. In this connection, Random-1 corresponds to the original joining scheme in Chord.

Different joining schemes were chosen to evaluate the impact of the node distribution over the overlay space on the performance of different load balancing schemes. After all nodes joined the system, attributes were added in the system with each attribute being randomly assigned a key, with the focus on the load balancing over each attribute tree. For this analysis, the inventors chose an attribute tree rooted at the node with maximum key space (indicating that the attribute tree is likely to be used for maximum number of attributes and thus have maximum load). 50 random networks were generated for each network size and each joining scheme. The subscription and publication messages were generated randomly and the origin node of each was randomly chosen. The origin node randomly selected a key and routed the message to that key. Thus, the number of publications and subscriptions messages a node processes and forwards to the root of the attribute tree is proportional to the key-space it is responsible for (independent of the original distribution of the messages).

A set of experiments were conducted to evaluate the impact of different node joining schemes on the load-balancing capability of the system. As described above, in the Shuffle system a node sheds load by offloading some processing (either by replication or splitting) to an immediate neighbor node that forwards traffic to it (the neighbor node has the concerned node as one of its direct fingers). The amount of load the node sheds is proportional to the amount of traffic that the neighbor node sends to it. In such a scenario, it is important that the amount of traffic that a neighbor node sends be proportional to the number of nodes that forward their traffic through it, i.e., a neighbor node hosting a large key space in its sub-tree with very few nodes is unlikely to lead to a highly balanced tree. This enables observation of how the key space is distributed with different node joining schemes.

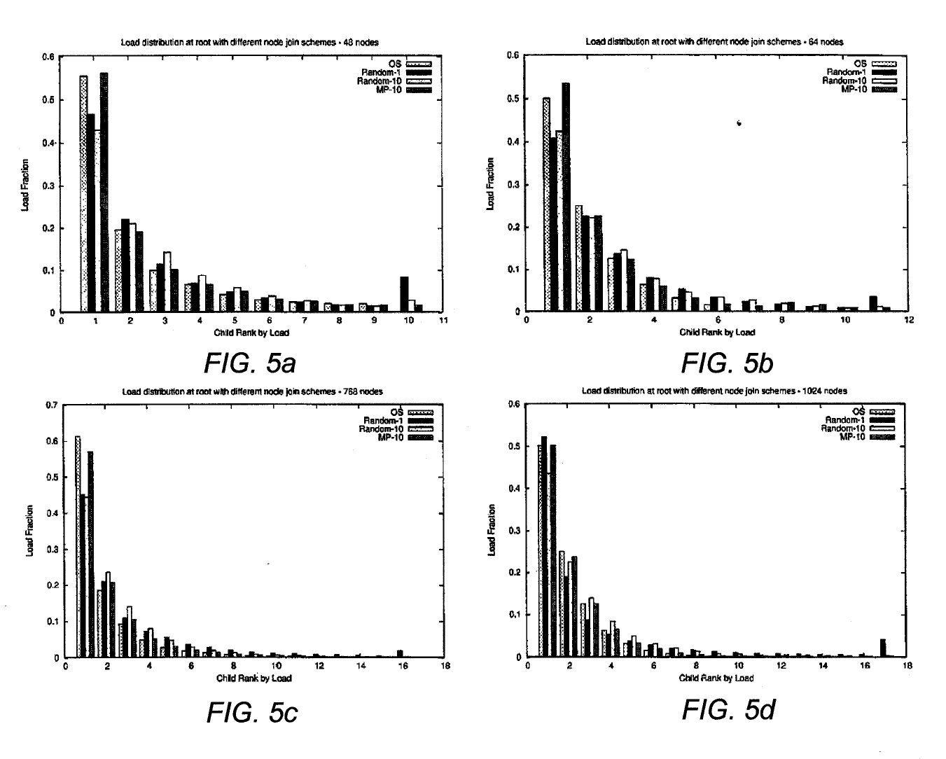

FIGS. 5a, 5b, 5c and 5d depict the distribution of the incoming load on the root node from all its children in the tree using the joining schemes described above for a network with 48, 64, 768 and 1024 nodes. The children nodes are ranked in decreasing order by the amount of load they forward and the figure plots these fractions. The last bar in each of the above figures represents the sum of remaining children for Random-1 and Random-10 cases. From this, it can be seen that using the OS scheme, the root node has exactly ½ of its load from one child, ¼ from the next child and so on for 64 and 1024 node scenarios. The load distribution is slightly skewed for the 48 and 768 node cases. For the Random-1 scheme, the distribution is highly skewed and there are a large number of children, each contributing a very small amount of the load as indicated by the long last bar. It will be appreciated by those skilled in the art, that a scenario where a large number of children each contribute a tiny load results in an inefficient resource usage for the Shuffle scheme, since such a node has to contact a large number of nodes to shed its load (in case it is highly loaded), and it has to keep entries corresponding to the nodes to which it sheds the load, thereby limiting scalability. The distribution is less skewed for the Random-10 scheme as compared to Random-1, and is even less skewed for MP-10.

Tables 1 and 2 depict the mean and standard deviation of the load distribution from the child which caused the top three greatest loads over all non-leaf nodes, with the largest represented by “Rank 1.

TABLE 1
Mean and standard deviation for various node joining schemes for 64 and 1024 nodes.

| | Number | Rank 1 | | Rank 2 | | Rank 3 | |
|---|---|---|---|---|---|---|---|
| Join Scheme | of Nodes | Mean | Std. Dev. | Mean | Std. Dev. | Mean | Std. Dev. |
| OS | 64 | 0.500000 | 0.000000 | 0.250000 | 0.000000 | 0.125000 | 0.000000 |
| | 1024 | 0.500000 | 0.000000 | 0.250000 | 0.000000 | 0.125000 | 0.000000 |
| Random-1 | 64 | 0.509445 | 0.218611 | 0.172710 | 0.089078 | 0.090013 | 0.055798 |
| | 1024 | 0.530674 | 0.212757 | 0.166589 | 0.091180 | 0.082744 | 0.051493 |
| Random-10 | 64 | 0.494687 | 0.173712 | 0.202902 | 0.080589 | 0.112333 | 0.054939 |
| | 1024 | 0.511662 | 0.171011 | 0.195256 | 0.083912 | 0.103293 | 0.054652 |
| MP-10 | 64 | 0.498167 | 0.075455 | 0.244982 | 0.042503 | 0.125782 | 0.026979 |
| | 1024 | 0.495718 | 0.075386 | 0.248286 | 0.042950 | 0.125055 | 0.026112 |

TABLE 2
Mean and standard deviation for various node joining schemes for 48 and 768 nodes.

| | Number | Rank 1 | | Rank 2 | | Rank 3 | |
|---|---|---|---|---|---|---|---|
| Join Scheme | of Nodes | Mean | Std. Dev. | Mean | Std. Dev. | Mean | Std. Dev. |
| OS | 48 | 0.486045 | 0.127790 | 0.242411 | 0.067739 | 0.126499 | 0.045653 |
| | 768 | 0.489567 | 0.121384 | 0.241254 | 0.061088 | 0.127613 | 0.041512 |
| Random-1 | 48 | 0.503151 | 0.212821 | 0.168828 | 0.089644 | 0.088026 | 0.050853 |
| | 768 | 0.527326 | 0.211755 | 0.164938 | 0.088871 | 0.083656 | 0.051738 |
| Random-10 | 48 | 0.487016 | 0.175687 | 0.205206 | 0.082625 | 0.111274 | 0.056842 |
| | 768 | 0.510626 | 0.171781 | 0.196701 | 0.085634 | 0.103192 | 0.054425 |
| MP-10 | 48 | 0.486789 | 0.124231 | 0.237937 | 0.064418 | 0.125015 | 0.045885 |
| | 768 | 0.488244 | 0.121180 | 0.241611 | 0.060610 | 0.128679 | 0.041661 |

From Tables 1 and 2, it can be seen that the deviation for MP-10 is consistently lower than that of Random-1 and Random-10. The deviation for OS is minimal among the four schemes for non-power-of-two cases (Table 1), and zero for power-of-two cases (Table 2). This indicates that each node is expected to have a more or less similar incoming load distribution from its children in OS and MP-10 cases, thus making these schemes more suitable for cascaded load balancing.

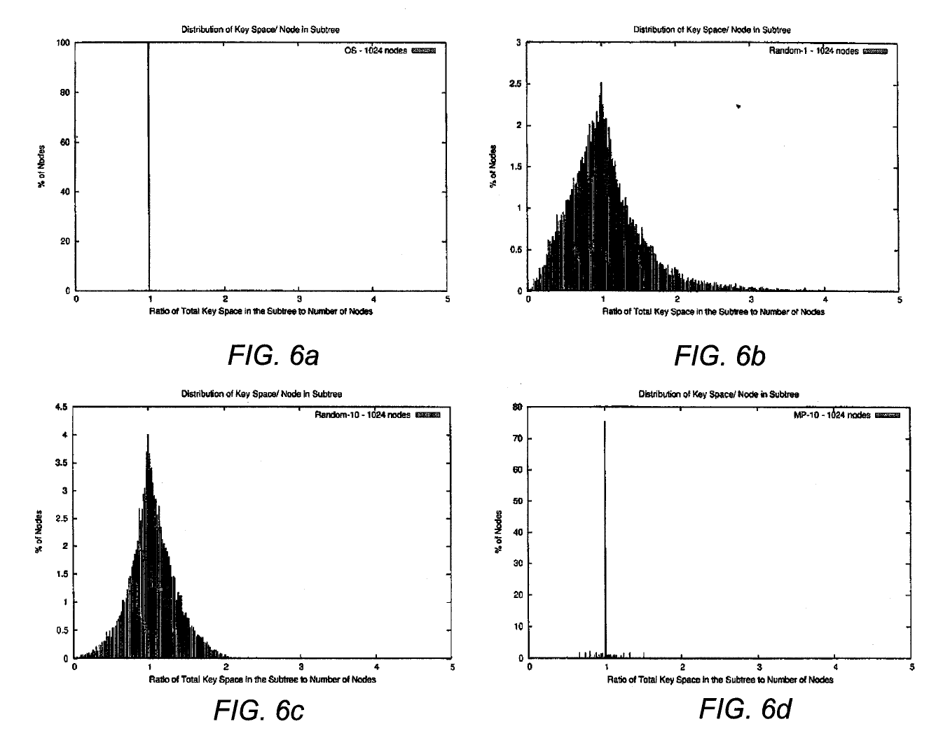

The inventors conducted another experiment to characterize the network structure created using the various node joining schemes involving the distribution of the key space on the routing tree to the root node. In this connection, each node in the tree holds a portion of the key space in its subtree (i.e., the union of key spaces of all the nodes descendants including itself). Ideally, in the cascading scheme a node sheds a fraction f of its load to a child, which is then responsible for that fraction of the load. Since the load forwarded by a child is proportional to the cumulative key-space in its subtree, in order to perfectly balance the load in a highly overloaded condition, such as when all nodes need to share some of the load, the number of nodes in the subtree should be should also be proportional to the key space it holds. In this regard, ideally the ratio of the key-space fraction at a node's subtree to the network size fraction in the subtree (i.e., the number of nodes in the subtree divided by the number of nodes in the system), should be as close to 1 as possible. FIGS. 6a, 6b, 6c and 6d respectively depict the distribution of this ratio for the OS, Random-1, Random-10 and MP-10 joining schemes for a network with 1024 nodes. FIG. 6a demonstrates that the OS scheme has a single bar at value 1, which indicates that all subtrees rooted at all nodes have exactly the same key-space fraction and network-size fraction rooted at the nodes, and thus perfect load balancing is attained. FIG. 6b shows that the Random-1 scheme results in a high concentration of values around 0 and a large tail, indicating the presence of many disproportionate subtrees in the structure. FIG. 6c shows the Random-10 scheme results are less skewed. FIG. 6d shows the MP-10 results as more packed with a plurality of values around 1.

The inventors demonstrated the load balancing performance of a shuffle algorithm in an operational scenario where the system is heavily loaded. Initially, a unit load on a root node was selected that indicated the total load for the corresponding attribute. Subsequently, a target load was chosen such that each node in the tree had a load no greater than the target value. The target load was varied between 1.1/n and 0.5 for a various number of nodes n. Since the total load on the system was normalized, a lower target load value (closer to 1/n) corresponds to a higher total load in the system. The lower the target value implies that the unit load will be shared by a larger number of nodes (indicating a higher total load). A target value of less than 1/n is not feasible for any system.

In the course of experimentation, the inventors considered the load being incurred due to a high publication rate, such that the root node used the Replicating-Holding scheme for event processing described above. In this connection, there were four metrics of interest: (1) the probability that the system would fail to reach the target load value; 2) the total number of control messages passed between nodes for the load balancing process; 3) the total fraction of subscriptions moved in the system; and 4) the total forwarding overhead in the system attributable to publication forwarding.

For comparing the load balancing performance, the inventors considered two other possible schemes:
Random—Half: where an overloaded node sends a control message to a random node to check if it is under-loaded (i.e., a load less than the target value). If the destination node is overloaded or has a higher load than the originating node, the originating node keeps sending control messages until it finds such a node (it will always find such a node when the target load is not more than 1/n). If so, it splits its load with that node by replicating only those subscriptions there which are not already present (the subscriptions could have originated there or have been replicated there by another node). If the load on the originating node is L and the load at the destination is L′, both the originating and destination nodes each have a load of 0.5(L+L′) and the originating node forwards a fraction of its publication traffic to the destination node accordingly. If the destination node also gets overloaded, it then searches for another node to shed its load.
Random—Min: where an overloaded node searches for an under-loaded node as in the Random-Half scheme. However, instead of splitting its load in half, the overloaded node delegates a bare minimum load equal to the target value to the chosen node by replicating its subscription set (less the subscriptions originating from that node) to the chosen node and forwarding a commensurate fraction of publication traffic to the chosen node. Thus, the only node that is ever over-loaded is the root node, which keeps searching for a new node to shed its load to until the root node has shed enough load to be less than the target value.

In this experiment, a node trying to find a random under-loaded node was considered to incur a single control message overhead, even if employing a DHT-based routing scheme to reach that node. This was done to be as lenient as possible in measuring the cost of competing systems. Such schemes are not scalable because a node may have to keep information about a large number of other nodes in a heavily loaded system. By way of contrast, Shuffle does not require storage of information about any other nodes except those nodes disposed in its log(n) fingers.

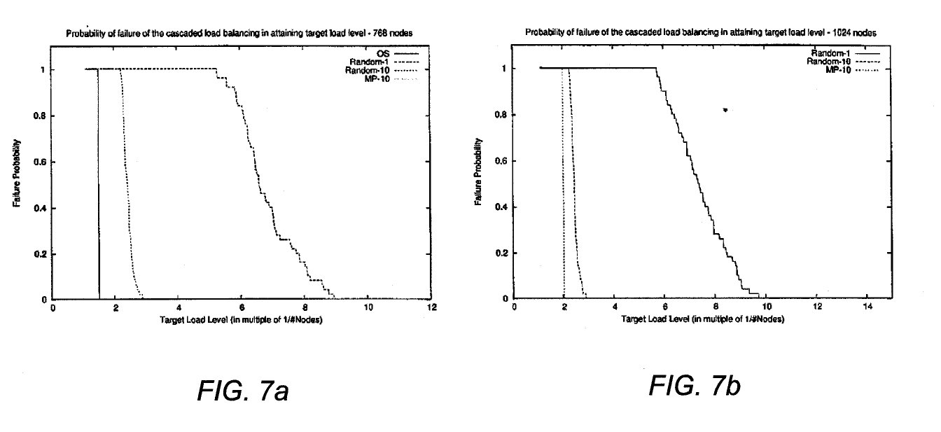

Failure Probability: The inventors first tested the probability of being able to achieve the target load level with increasing load (given by reduced target load level) using the cascaded load balancing scheme. As described above, note that the system could fail to achieve a target load value, even if the target load is greater than 1/n because of the non-uniform relative distribution of key-space and nodes in the underlying structure. Thus, cascaded load-balancing can fail in case there are too few children in a sub-tree which is handling a large key space. FIGS. 7a and 7b are plots depicting the probability that the scheme is unable to meet the target load at all the nodes for different join schemes for networks sizes of 768 nodes and 1024 nodes, respectively. With a lower target load value, the probability of failure (i.e., meeting target load) is high. Note that the failure probability is very high at even medium load levels of around 5/n when we used the Random-1 scheme was employed. With an OS scheme, a target level of less than 1.4/n cannot be achieved; however, all subsequent levels are addressed. An MP-10 scheme is very close to the OS scheme from this perspective (shown for a 768 node case). It can be seen that, with an OS scheme and power-of-two network size, load-balancing will always be attained at even the 1/n target level (as evidenced by the distribution shown in FIG. 6 for 1024 nodes) and hence there is no curve corresponding to OS for 1024 nodes case. This further justifies the viability of the OS and MP-10 joining schemes for cascaded load balancing as opposed to Random-k schemes.

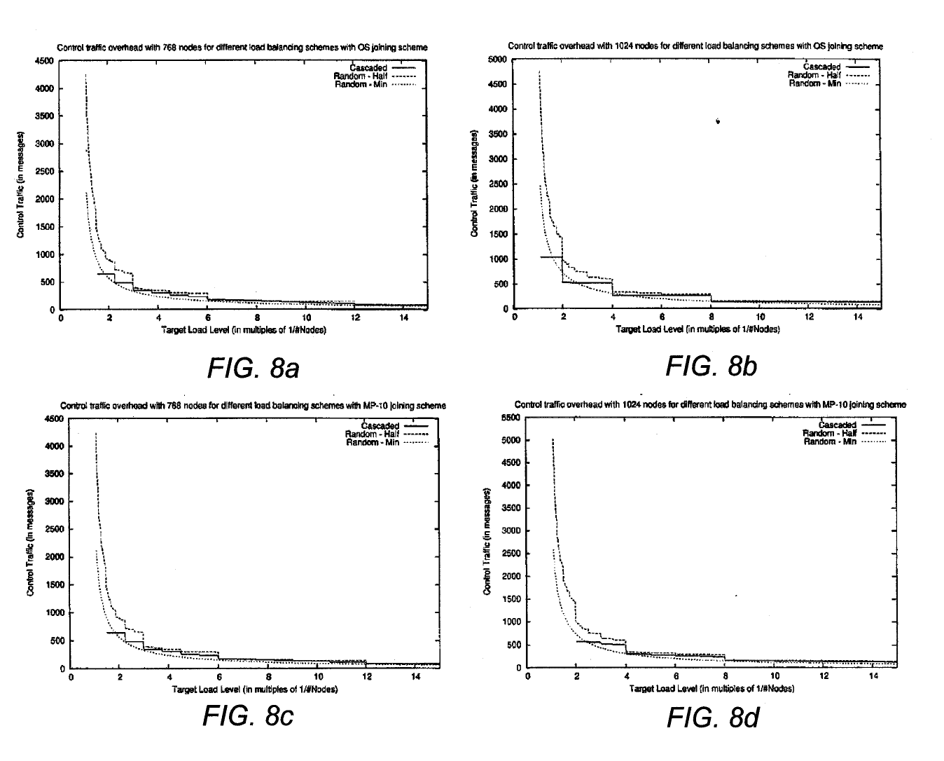

Control Message Overhead: FIGS. 8a, 8b, 8c and 8d illustrate the number of control messages sent in the system to attain the load balancing vs. target load level. FIGS. 8a and 8b depict an OS joining scheme for networks with 768 and 1024 nodes, respectively. FIGS. 8b and 8c depict an MP-10 joining scheme for networks with 768 and 1024 nodes, respectively. Each case shows results for cascading, Random-Half and Random-Min schemes. From these results, it can be seen that the number of control messages increase with a decrease in the target load value. This is because a larger number of nodes need to be contacted to divide the load among these nodes. However, the number of messages sent out by Random-Half and Random-Min schemes jump significantly when the target load value is small. This is because at lower target load values, a large number of nodes need to be involved in the load sharing. Thus, it becomes difficult for a node to find an unloaded node to which to shed its load (since a large fraction of the nodes are already sharing the load for other nodes). The load is higher for the Random-Half scheme as compared to Random-Min scheme at high load levels. This is the case because in Random-Min, only the root node searches for under-loaded nodes, whereas in Random-half, several nodes can be overloaded and thus send out control messages.

FIGS. 8a, 8b, 8c and 8d evidence a stair-case profile of the control overhead curve for the cascaded load-balancing scheme. In both the OS and MP-k schemes, a new node takes exactly half of the key space from the prior node when joining the overlay. Thus, they are likely to create several nodes with an equally shared key space (as is also evident from the load distribution in FIGS. 5 and 6). Since a node holding a fraction f of the key space gets a load of f from its parent, all these nodes will get overloaded at the same target load level, and thus shed loads onto their children at the same target load level. This “stair-case” behavior of the cascaded scheme is likewise shown in the subscription message overhead illustrations described below.

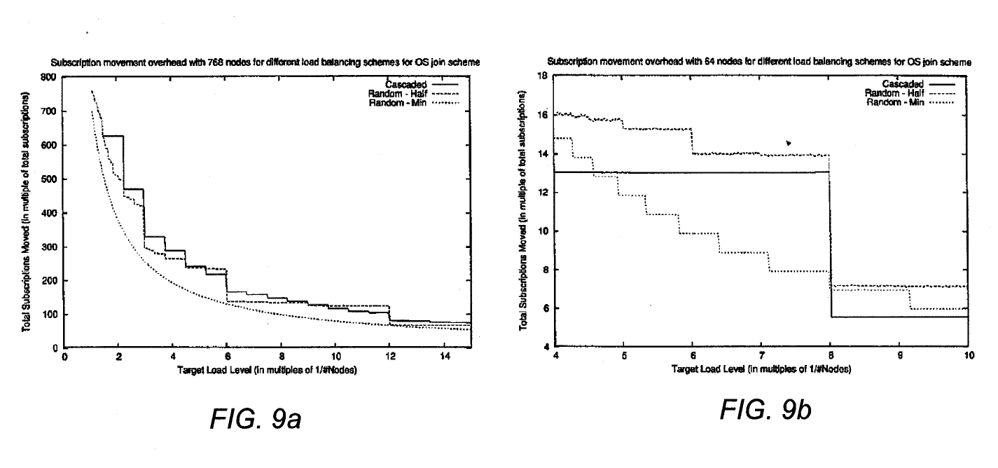

Subscription Movement Overhead: This metric of interest concerns the amount of subscriptions that need to be transferred in the load balancing process. FIGS. 9a and 9b depict the total number of subscriptions moved in terms of the number of copies of the entire subscription database that were transferred vs. target load level for networks with 768 nodes and 64 nodes, respectively, using the OS join scheme. Random-Min serves as a baseline case for subscription movement as the root node only contacts the minimum number of nodes required to attain the target load level. For the 768 node case (FIG. 9a), it can be seen that the cascading scheme, Random-Min and Random-Half have a comparable overhead. FIG. 9b plots a smaller portion of a target load level for 64 nodes. FIG. 9b shows the initial savings that a cascading scheme can initially attain because of the en-route caching of subscriptions, which only requires that a fraction of subscriptions be replicated. In this regard, in the initial replication stages the overhead can be lower than Random-Min. However, the cascading scheme's overhead jumps significantly due to the stair-case effect described above.

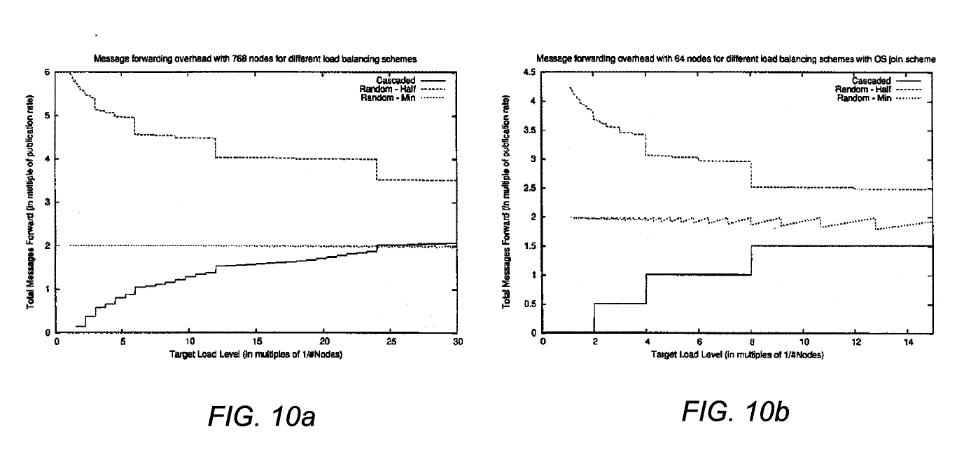

Forwarding Traffic Overhead: FIGS. 10a and 10b shows the publication message forwarding overhead (in multiples of the total publication rate) of the three load balancing schemes for 768 and 64 nodes, respectively. The basic Shuffle system incurs an extra forwarding load for messages being routed to the root node giving it an initial forwarding load. This shows up as the total load in the cases with high target load values. However, for low target load values (i.e., a highly-loaded system) the forwarding load is reduced in the Replicating-Holding mode as the child replica node locally handles all the publications originating from its subtree. Effectively, the attribute tree splits into half with each replication.

In contrast, using the Random-Half scheme the system initially has a low load (i.e., equal to the original publication rate as all nodes directly forward to the root node). As the system becomes overloaded, the overloaded nodes start shedding load by replicating onto other nodes and forwarding a fraction the publication messages to these other nodes. This increases the forwarding traffic overhead when the system is overloaded. In the Random-min scheme, since the root node directly forwards the appropriate fraction of publications to the nodes which share its load, the total publication traffic is never more than twice the total publication rate (i.e., a factor of one corresponding to the nodes forwarding messages to the root and another factor of one for the root appropriately forwarding to the other load-sharing nodes).

An interesting phenomenon can be observed from FIG. 10b, regarding the Random-Min scheme in connection with the 64 node example. Here, it can be seen that the forwarding overhead follows a saw-tooth pattern. This is explained by the discrete jumps in the number of nodes required to attain a target load level. Considering a target load level L, the number of nodes N required to attain this load level is

$$⌈ \frac{1}{L} ⌉ .$$

Since the root node assigns a load equal to L to each of the N nodes, the total forwarding load is 1+NL (where 1 accounts for the incoming rate to the root node). As L decreases, the value of 1+NL decreases until it reaches a value so that the required number of nodes to handle the load increases to N+1 (causing the sudden jump in FIG. 10b).

In summary, for the Random-Half scheme the forwarding overhead increases with increased load level, for the Random-Min scheme, it remains bounded by a constant, and for the cascading scheme the load decreases. This is a very desirable property where the forwarding overhead is diminished with an increasing load on the system.

The above described load balancing results are for replication, which occurs when a high publication rate is the cause of overload. For splitting (i.e., when a very large number of subscriptions is the cause of the overload), the results for the system remain almost similar as the above set. Assuming the same model as above, where the unit load needs to be reduced to a given target load), a similar number of control messages is incurred as the splitting process is implemented along the tree in an identical fashion. This expedient does not incur any subscription movement cost since the child node already has cached the subscriptions forwarded from its sub-tree (i.e., proportional to the total load it sends to its parent). Similarly, the failure probability distribution is identical to the previous case.

Experiments were conducted to demonstrate the availability of subscriptions in the presence of node failures for increasing failure probability. These experiments show system robustness, even when facing a high probability of node failures. Fundamentally, this arises from the enroute caching scheme where each node on a DHT forwarding path of a subscription stores a local copy of the subscription prior to forwarding it to the node responsible for that subscription.

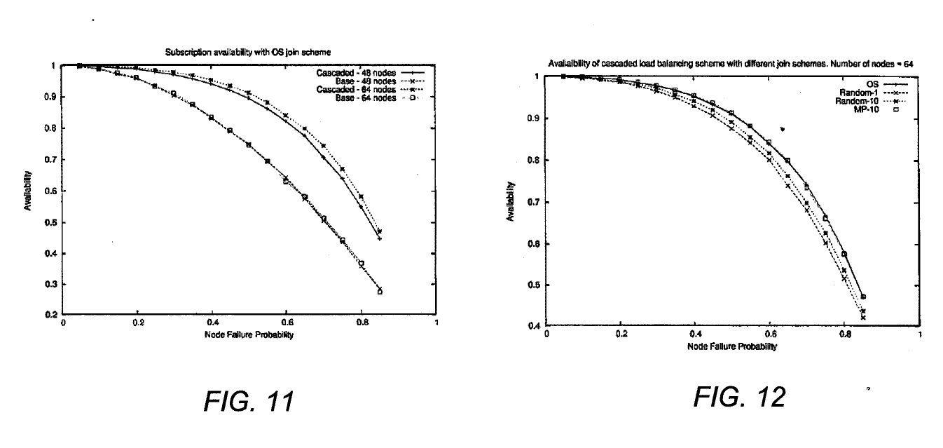

The inventors modeled node failures as independent events occurring with various probabilities. A subscription is deemed to have been lost if no copies are available at any of the functioning nodes in the network. FIG. 11 shows the availability of subscriptions in the presence of node failures for increasing failure probability. It compares the availability with a base caching scheme where the subscription is cached at its origin node and at the root node. It can be seen that even with a very high failure probability, a substantial fraction of subscriptions remain available in the system with cascaded caching. Likewise, it can be seen that a base load balancing scheme performs poorly due to insufficient caching in the system. This justifies the intuitive choice of caching a subscription along the forwarding path.

FIG. 12 plots the availability of subscriptions on a network of 64 nodes for different node joining schemes. It can be seen that the availability of the Random-1 scheme is lowest, due to the fewer available caches from uneven partitioning. Furthermore, MP-10 performs very close to OS from the availability perspective.

The present invention has been shown and described in what are considered to be the most practical and preferred embodiments. It is anticipated, however, that departures may be made therefrom and that obvious modifications will be implemented by those skilled in the art. It will be appreciated that those skilled in the art will be able to devise numerous arrangements and variations which, although not explicitly shown or described herein, embody the principles of the invention and are within their spirit and scope.

We claim:

1. A method for balancing network workload in a publish/subscribe service network, the network comprising a plurality of nodes that utilize a protocol where the plurality of nodes and publish/subscribe messages are mapped by the protocol onto a unified one-dimensional overlay key space, where each node is assigned an ID and range of the key space and where each node maintains a finger table for overlay routing between the plurality of nodes, and where event and subscription messages are hashed onto the key space based on event attributes contained in the messages, such that an aggregation tree is formed between a root node and child nodes among the plurality of nodes in the aggregation tree associated with an attribute A that send messages that are aggregated at the root node, comprising:
receiving aggregated messages at the root node for processing of the aggregated messages; and
upon detecting excessive processing of the aggregated messages at the root node, rebalancing network workload by pushing a portion of the processing of the aggregated messages at the root node back to a child node in the aggregation tree.

2. The method recited in claim 1, further comprising:
a node x receiving an original subscription message m for redistribution in the network;
the node x picking a random key for subscription message m;
the node x sending the subscription message to a node y, where the node y is responsible for the key in the key space;
parsing the subscription message at the node y and constructing a new subscription message n; and
sending subscription message n to the root node z and replicating the subscription message n at each node in the network between the node y and the root node z, wherein each node in the aggregation tree records a fraction of subscription messages forwarded from a child of the node in the aggregation tree, and further wherein the root node z is identified by picking an attribute A contained in m and hashing A onto the overlay key space.

3. The method recited in claim 2, wherein when the root node z is overloaded with subscription messages from the aggregation tree; further comprising:
the root node z ranking all child nodes by the fraction of subscription messages forwarded to node z from each child node and marking the child nodes as being in an initial hibernating state;
the root node z selecting a node I with the largest fraction of subscription messages among the hibernating child nodes;
the root node z unloading all subscription messages received from the node l back to the node l;
the root node z marking the node l as being in an active state, and forwarding all subsequent subscription messages in an event aggregation tree associated with attribute A to the node l.

4. The method recited in claim 3, further comprising:
a node x receiving an original event message m for redistribution in the network;
the node x picking a random key for the event message m;
the node x sending the event message to a node y, where the node y is responsible for the key in the key space;
parsing the event message at the node y and constructing a new event message n; and
sending the event message n to the root node z and replicating the event message n at each node in the network between the node y and the root node z, wherein each node in the aggregation tree records a fraction of event messages forwarded from a child of the node in the aggregation tree, and further wherein the root node z is identified by picking each attribute A contained in m and hashing A onto the overlay key space.

5. The method recited in claim 4, wherein when the root node z is overloaded with event messages from the aggregation tree; further comprising:
the root node z ranking all child nodes by the fraction of event messages forwarded to the node z from each child node and marking the child nodes as being in an initial hibernating state;
the root node z selecting a node l with the largest fraction of event messages among the hibernating child nodes;
replicating all messages from the subscription aggregation tree for attribute A at the node l and requesting that the node l hold message forwarding and locally process event messages; and
the root node z marking the node l as active.

6. The method recited in claim 1, further comprising adding a new node to the network using an optimal splitting (OS) scheme.

7. The method recited in claim 6, wherein the OS scheme comprises the new node joining the network by:
finding a node owning a longest key range; and
taking ½ of the key range from the node with the longest key range.

8. The method recited in claim 7, wherein if a plurality of nodes have an identical longest key range, randomly picking one of the nodes owning the identical longest key range

9. The method recited in claim 1, further comprising removing a node x from the network using an optimal splitting (OS) scheme.

10. The method recited in claim 9, wherein the OS scheme comprises removing the node x from the network by:
the node x finding a node owning a shortest key range among the plurality of nodes and an immediate successor node; and
the node x instructing the node owning the shortest key range to leave a current position in the network and rejoin at a position of node x.

11. The method recited in claim 10, wherein if the immediate successor node owns the shortest key range, instructing the immediate successor node to leave a current position, and further wherein if the immediate successor node does not own the shortest key range and a plurality of nodes own the shortest key range, randomly picking one of the nodes having the shortest key range.

12. The method recited in claim 1, further comprising adding a new node to the network using a middle point splitting (MP-k) scheme.

13. The method recited in claim 12, wherein the MP-k scheme comprises the new node joining the network by:
randomly choosing K nodes on the overlay space and if a plurality of nodes among the K nodes have longest key range, randomly selecting a node among the plurality of nodes with the longest key range.

14. The method recited in claim 1, further comprising removing a node x from the network using a middle point splitting (MP-k) scheme.

15. The method recited in claim 14, wherein the MP-k scheme comprises removing the node x from the network by:
the node x picking K random nodes and an immediate successor node in the network; and
the node x selecting a node owning the shortest key range and requesting that the node owning the shortest key range leave a current position in the network and rejoin at a position of node x,
wherein, if the immediate successor node to node x has the shortest key range, giving priority to the immediate successor node to node x, and further wherein if the immediate successor node to node x does not own the shortest key range and a plurality of nodes among the K random nodes own the shortest key range, randomly selecting a node among the plurality of nodes owning the shortest key range.

16. The method of claim 5, further comprising scheduling an order of load balancing operations at an overloaded node root node n among the plurality of nodes, wherein node n is simultaneously overloaded by event and subscription messages by:
node n determining a target processing rate r:
signaling a plurality of child nodes to node n to stop forwarding event messages to node n such that an actual arrival rate of event messages at node n is no greater than r;
determining an upper bound th on the number of subscription messages that can be processed at node n based on r;
signaling a plurality of child nodes to node n to stop forwarding subscription messages based on th; and
unloading subscription messages from node n to the plurality of child nodes.
